(19) United States
(12) Patent Application Publication
(10) Pub. No.: US 2013/0019814 A1
(43) Pub. Date: Jan. 24, 2013

(54) Dog Handling Apparatus

(71) Applicant: Eric John Thibault, Sherman Oaks, CA (US)

(72) Inventor: Eric John Thibault, Sherman Oaks, CA (US)

(73) Assignee: The Pet Director, LLC, Granada Hills, CA (US)

(21) Appl. No.: 13/552,441

(22) Filed: Jul. 18, 2012

Related U.S. Application Data
(60) Provisional application No. 61/510,412, filed on Jul. 21, 2011.

(51) Int. Cl. A01K 27/00

(52) U.S. Cl. 119/799

(57) ABSTRACT

An article for animal training, the article includes a curved cylinder shaft having a first end and second end. A grip is coupled to the first end of the shaft and a spring mechanism is coupled to the second end of the shaft. A clip is coupled to the spring mechanism to engage an animal collar or harness. The spring mechanism can be covered by a sheath. The article provides improved control for a handler through better communication with the animal.

### CROSS REFERENCE TO RELATED APPLICATION

The present application claims priority from U.S. Provisional Patent Application No. 61/510,412 titled “Dog Leash,” which was filed Jul. 21, 2011.

### FIELD OF INVENTION

The embodiments of the invention relates to dog handling equipment, specifically to an apparatus for training and walking a dog.

### BACKGROUND

There are 77.5 million dogs in the United States. Thirty nine percent (39%) of U.S. households own at least one dog. Most dog owners take their pets out for walks and utilize a leash to control the dogs during these walks. Most leashes are nylon straps that are connected at one end by a metal fastener to the dog's collar. At the other end of the leash the handler grips a loop in the nylon strap. Other variations of the basic dog leash include a nylon strap that is attached to a spool and handle mechanism, whereby the handler can adjust the amount of leash given to the dog, this mechanism automatically retracts as the dog nears the handler.

However, the basic dog leash is designed to give freedom to the dog to roam about while retaining only a minimum amount of control for the handler. The only control for the handler is in the amount of leash (i.e., the length) at which the dog can separate itself from the handler. As a result, dog walking habits utilizing these leashes do not promote obedience or promote the safety of the dog, the handler or the passersby. With the amount of slack given by basic or retracting dog leashes, the dog can gain a running start causing the handler to lose control or potentially causing injury to the dog due to the sudden restraint of the dog when the end of the leash is reached.

Further, the basic leashes are unsuitable for any type of training regimen which requires the dogs to be in close communication with the handler such that the handler can position the dog and restrain the dog to enable training the dog, walking the dog and other purposes. Furthermore, the basic leash is unable to adequately restrain the animal from coming into contact with passersby or the environment, because the handler can only control a diameter of range for the dog at best and can become quickly entangled in the leash as the dog circles further making it difficult for the owner to control the dog risking injury for the dog and handler.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram of one embodiment of the dog handling apparatus.

FIG. 2 is a diagram of another embodiment of the dog handling apparatus showing the constituent parts.

FIG. 3 is a diagram of one embodiment of the cross section of the dog handling apparatus.

FIGS. 4 and 5 are diagrams of one embodiment of a spring for the dog handling apparatus.

FIGS. 6 and 7 are diagrams of one embodiments of the handle for the dog handling apparatus.

FIGS. 8, 9, 10 and 11 are diagrams of dog handling positions enabled by the dog handling apparatus.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known parts, structures, and techniques have not been shown in detail so as not to obscure the understanding of this description.

The embodiments of the invention involve a dog handling apparatus that has a design that enables not only the conventional walking of the dog, but also the training of the dog by the dog's handler. The dog handling apparatus can be utilized to teach the dog proper walking skills for balanced, safer and healthier walks as well as other related techniques. The dog handling apparatus provides a more controlled connection between the dog and the handler. This more controlled connection leads to faster and better communicate between the dog and the owner.

Using this dog handling apparatus the dog does not feel unattached from the handler giving the dog a sense of connection and security which enables a structured, stable and confident training of the dog. The handler is able to manage the dog on either the right side or left side of the handler, even in congested environments while maintaining a maximum level of control. The dog apparatus provides a spring suspension system that absorbs the shock of pulling, jerking and tugging by the dog thereby providing the handler with forewarning of sudden movements and then enabling a quick response for control and a correction of the dog's behavior with minimal effort.

As a result of the improved communication with and control of the dog there is reduced risk of injury of the dog due to quick pulling of the leash or sudden restraint by the handler which impacts the soft tissues and joints of both the handler and the dog. The dog handling apparatus provides minimal ability for the dog to obtain a running start, which can result in loss of control of the animal and may knock the handler off balance or result in the total loss of control over the dog. Further, the dog handling apparatus avoids the pitfalls of traditional leashes that can become wrapped around the ankles or legs of the handler. The dog handling apparatus achieves this without having to utilize more constraining, questionable tools such as choke or spike collars.

The dog handling apparatus thereby sets boundaries and parameters for teaching walking and etiquette to an animal. The handler is able to set the pace and train the animal to have a soft temperament. Training is less frustrating and more consistent and keeps the dog calm and responsive in contrast to a traditional leash which gives the dog free reign and allows the dog to become excited in response to the actions of the handler, passersby or the environment. The dog handling apparatus provides a means for creating a bond between the dog and the handler by constant contact between and consistent control between the handler and the dog resulting in more pleasurable walks for both the handler and the dog as well as a greater degree of obedience in the dog.

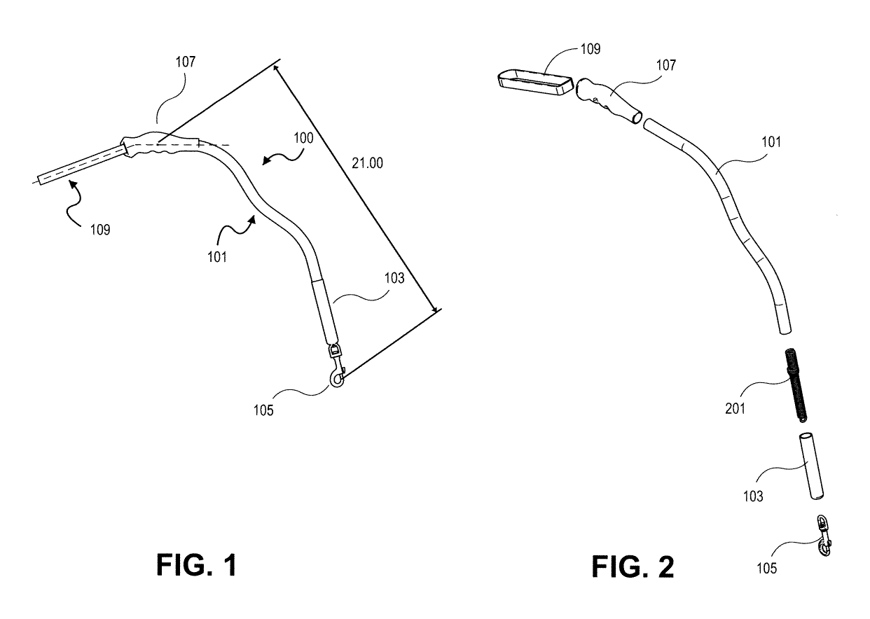

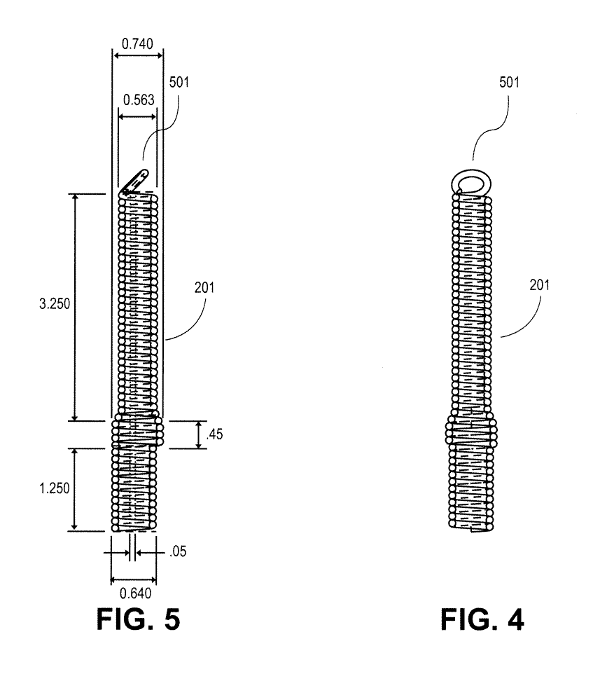

FIG. 1 is a diagram of one embodiment of the dog handling apparatus. The dog handling apparatus 100 includes a central shaft 101, a bite guard 103, a grip 107, a lanyard 109 and a clasp 105. In one embodiment, the shaft 101 can be formed from aluminum, aluminum alloy or similar material providing a rigid construction. The shaft 101 can be formed by molding, extrusion or similar process. The shaft 101 can be a hollow tube or solid shaft. In one example embodiment, the shaft 101 is a 21 inch tube having a 0.75 inch diameter and a 0.06 inch wall thickness. The shaft 101 can have any length and diameter suitable for use with small or large dogs as well as large or small handlers. The shaft 101 can have rounded, cornered or squared walls. The shaft 101 can be directly or indirectly coupled to the bite guard 103 and the grip 107. The shaft 101 can have roughly cylindrical shape and define a set of bends described in further detail in relation to FIG. 3. These bends are defined to enable the positioning of the dog relative to the handler in a tight and controlled communication, some of these positions are described below in relation to FIGS. 9-12.

The grip 107 can be attached to a first end of the shaft 101. The grip 107 can be attached to the shaft 101 via a form fit, adhesive, interlocking mechanism or similar attachment mechanism. The grip 107 can be formed from SANTOPRENE by Exxon Mobile (or similar thermoplastic elastomer), natural or synthetic rubber, plastic or similar material suitable for providing a grip for a handler's hand that is comfortable and non-abrasive but still providing sufficient friction to enable the handler to securely hold the handling apparatus when the dog is pulling away from the handler. The grip 107 can have any shape or form suitable for interfacing with the human hand. In one embodiment, the grip 107 is hollow enabling it to slide over and interface with the shaft 101. In another embodiment, the grip is substantially solid and interlocks with the end of the shaft 101. The grip 107 can have any size proportionate to the shaft 101 and the average size of the human hand, for example the grip can have a length of two to four inches and a diameter of one to two inches. The grip 107 can also provide an attaching mechanism for the lanyard 109. The lanyard 109 can be a nylon strap or similar structure that can be wrapped around the wrist of a handler to provide an additional level of security and convenience to the handler.

The opposite end of the shaft 101 can be coupled to a bite guard 103. The bite guard 103 can be formed of SARLINK by Teknor Apex (or similar thermoplastic elastomer), natural or synthetic rubber, SANTOPRENE or a similar material with sufficient rigidity and flexibility to protect the encased spring and to prevent the handler or the dog from coming into contact with the spring such that the skin or hair of the handler or the dog can be pinched or caught in the spring. The bite guard 103 can be attached to the end of the shaft by adhesive, faun fit, interlocking parts or similar attachment mechanism. The bite guard 103 can be hollow and able to serve as a sheath to cover or encase the interior spring and a portion of the shaft 101. The spring within the bite guard 103 can be connected to a clasp 105. The bite guard 103 can define an opening through which the spring can be coupled to the clasp 104. The bite guard 103 can have a length of two to five inches and a cylindrical shape roughly commensurate with that of the shaft 101 with a similar diameter and shape.

The clasp 105 can be constructed, molded, handcrafted or extruded from metal or metal alloys with sufficient strength to secure the dog handling apparatus to the attachment points on a collar or harness of a dog. The clasp 105 can include a spring loaded closing mechanism and a hook whereby the closing mechanism in combination with the hook defines a closed loop around which an attachment point of the collar or harness can be secure. The clasp 105 can also be formed with a swivel point or similar attaching mechanism to enable the clasp to rotate 360 degrees at its base around the attachment point of the spring, thereby enabling the dog handling apparatus to rotate around the attachment point of the collar or harness without having to disengage the clasp 105 from the collar thereby enabling a free range of motion between the collar and the dog handling apparatus. The clasp 105 when closed can also define a loop of sufficient size to interlock with more than one attachment point such as multiple short leashes that allow the dog handling apparatus to couple to multiple dog collars or harnesses such that the handler can walk multiple dogs at one time.

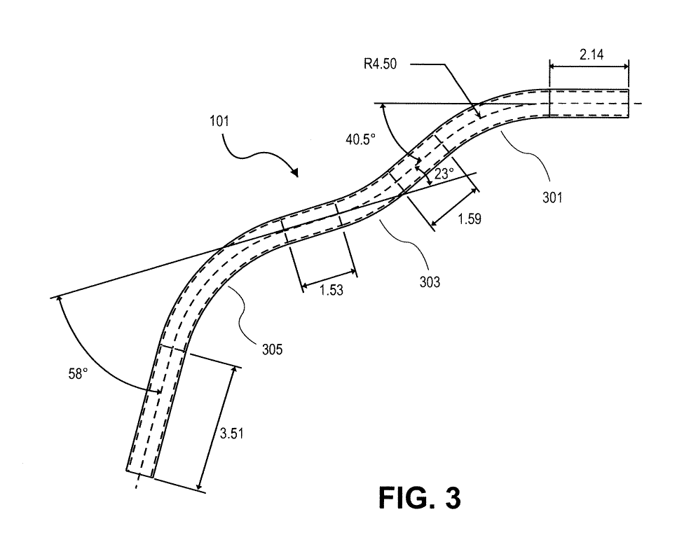

FIG. 2 is a diagram of one embodiment of the dog handling apparatus showing the constituent parts of the dog handling apparatus separated from one another. The parts include the lanyard 109, the grip 107, the shaft 101, the spring mechanism 201, the bite guard 103 and the clasp 105. The grip 107, shaft 101, spring mechanism 201 and bite guard 103 can all have a roughly cylindrical shape with complimentary interior and exterior diameters enabling them to fit one within the other to form the handling apparatus. The matching cylindrical shapes, cross-sections, diameters and similar dimensions provide a uniform appearance and avoid rough edges where the dog handling apparatus might catch or snag on the clothing of the handler or the hair of the dog.

The spring mechanism 201 can be formed from any metal or metal alloy that provides sufficient tension to counterbalance the weight or force of a dog pulling on the end of the dog handling apparatus, thereby providing a cushion or flexibility to the attached shaft 101 through the collar of the dog to the clasp 105. The spring mechanism 201 can have any length or diameter commensurate with the dog handling apparatus. The spring mechanism 201 can be a coil spring or similar type of tension/extension spring.

FIG. 3 is a diagram of one embodiment of the cross section of the shaft 101. The cross section illustrates one embodiment of the shape of the shaft. As mentioned above the shaft can have a roughly twenty one inch length. However, one skilled in the art would understand the length and dimensions of the shaft can vary proportionately depending on the intended size of the handler or the animal. In one example embodiment, the shaft 101 includes a series of bends that provide a shape around which the shaft can be manipulated such that the shaft can rotate around the neck and shoulder of the animal as well as the hip and arm of the handler. In one embodiment, the shaft includes a set of three bends including a first bend 301 having a 40.5° angle from the endpoint of the shaft 101. The portion of the shaft near the endpoint of the shaft can be approximately 2.14 inches long and after the bend lead to another straight section having a length of 1.59 inches. This straight section can then lead to a 23° bend 303 between this straight section and the next straight section. The third straight section can have an approximately 1.53 inch length. This traversal of the shaft then reaches a third bend 305 having a 58° angle relative to the end portion of the shaft 101, which can have a final straight section with a length of 3.51 inches. One skilled in the art would understand that the degrees of the turns and the lengths of the sections can vary proportionately and absolutely relative to one another remaining consistent with the use and the design of the dog handling apparatus. Each of the straight sections can have varying lengths within a range of plus or minus four inches from the example lengths. Similarly, the bends can have varying turn degrees within a range of plus or minus 15°.

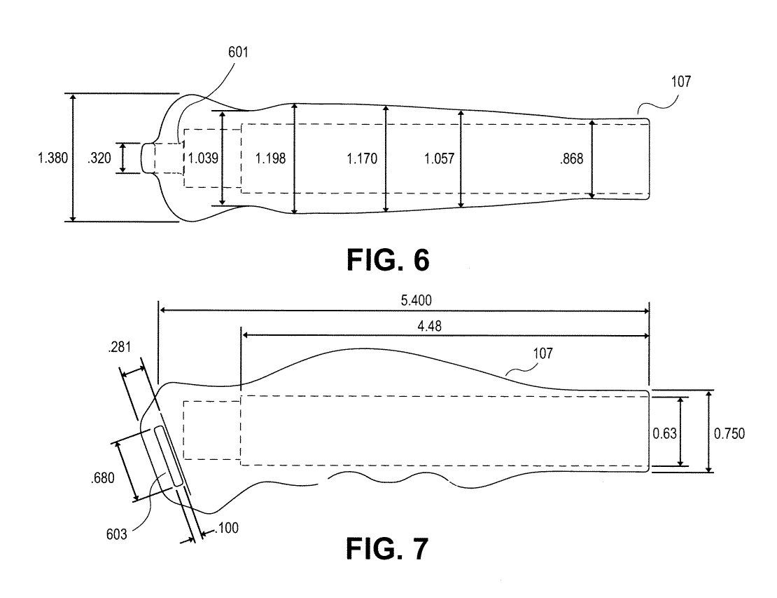

FIGS. 4 and 5 are diagrams of one embodiment of the spring mechanism 201. The spring mechanism can have any length or diameter commensurate with the size and shape of the shaft. In one embodiment, the spring mechanism 201 has varying diameters over its length and the central axis is offset at a transition section providing a tailored level and range of resistance to the interaction between the collar of the dog as it pulls on the dog handling apparatus and the shaft. In one embodiment, the spring mechanism 201 includes an end loop 501 having a 45° angle from the end of the spring mechanism 201, which can be used to engage the attachment mechanism of the clasp. In other embodiments, other types of interlocking parts or attachment mechanisms can be provided to couple the spring mechanism 201 with the clasp.

The spring mechanism 201 can have an exterior diameter than ranges from 0.74 inches to 0.563 inches and includes a 0.64 inch diameter section. The widest section of the spring mechanism 201 can be the interior transition section. In one embodiment, the three sections of the spring 201 can include a first section that is 1.25 inches in length, an interior transition section having a 0.45 inch length and a third segment having a 3.25 inch length. The shorter initial section may be designed to be housed entirely within the interior of the shaft, while the longest section may be designed to be exterior to the shaft and the transition section can also be disposed exterior to and/or adjacent to the end of the shaft. The spring mechanism 201 can be form fit into the end of the shaft, may be adhered to the end of the shaft. The spring mechanism 201 can be attached to the shaft of the dog handling apparatus by a number of methods including being welded to the end of the shaft or interior of the shaft, threaded into the shaft, attached via adhesive or through a similar attachment process and mechanism.

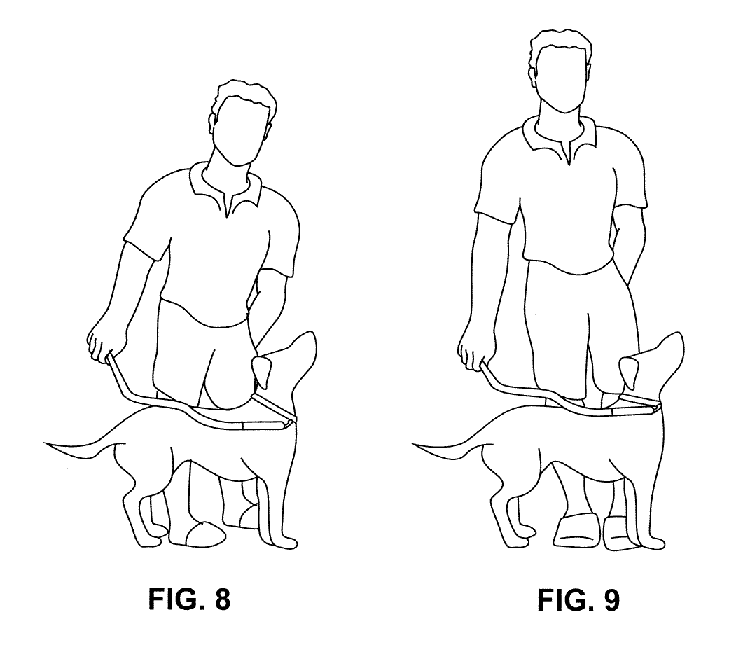

FIGS. 6 and 7 are diagrams of two separate embodiments of the grip. In one embodiment, the grip 107 is designed and formed from a thermoplastic elastomer such as SANTOPRENE or a similar material and can have a weight of approximately 51 grams and a volume of 3.2 cubic centimeters, defining a hollow interior space having at least one diameter and possibly two separate diameters over its length such that it can cleanly fit onto and over the end of the shaft while providing a space at one end for a possible additional attach mechanism to interface with the lanyard. In one embodiment illustrated in FIG. 6, the interior of the grip 107 defines a space for attach mechanism and a passage 601 through which the lanyard and/or the lanyard attachment mechanism can pass. In one embodiment, the grip 107 can have a tapering form starting at its widest point near the end of the grip furthest from the shaft and tapering towards the end of the grip closest to the shaft of the dog handling apparatus. The exterior diameter of the grip can vary from less than 1 inch to approximately 1½ inches in diameter including, for example, a 0.868 inch diameter and extending out to a 1.38 inch diameter. The diameter of the opening for receiving the shaft defined by the grip can be less than half an inch, for example a 3.2 inch diameter.

In another embodiment, illustrated in FIG. 7, the grip 107 may define an opening to the interior space at only one end and instead defines a separate slit or passage 603 through which a lanyard loop can be disposed. For example, in one embodiment, the opening slit or passage 603 may be approximately 0.68 inches in length and approximately 0.1 inches in width, while the protruding structure defining the opening 603 is approximately 0.281 inches in length.

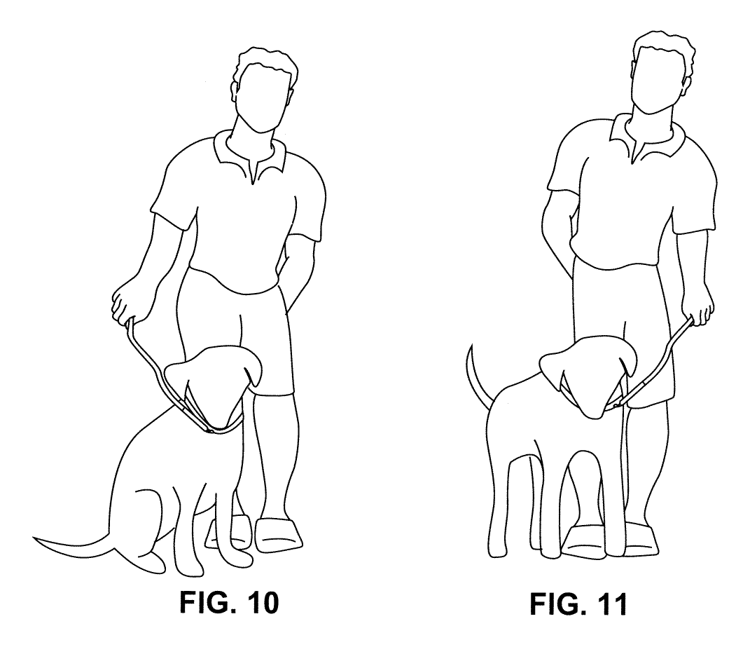

FIGS. 8, 9, 10, and 11 demonstrate a series of walking or training positions between the dog handler and the dog using the dog handling apparatus. In FIG. 8, the illustration shows that the dog handler can restrain the walking or standing animal by being positioned adjacent to the animal and pulling back or holding the grip near the rear of the animal, thereby preventing the animal from advancing relative to the handler while still engaging the animal's collar near the bottom or front of the collar thereby not initiating a choking or similar action against the animal while at the same time positioning the animal and preventing its advancement.

FIG. 9 shows a more relaxed positioning whereby the handler is standing upright rather than slightly hunched over the animal, allowing the animal to more freely in advance of the handler such as during walking or similar movement. The bends of the handling apparatus curve over the back of the animal towards the handler such that the handler may comfortably position his hand over the back or to the side of the animal while walking or standing adjacent to the animal. Again, where the handling apparatus is disposed such that it still engages the collar near the front or the outside of the collar rather than the rear of the collar where the animal may feel constrained.

FIG. 10 shows a position of the handler while the dog is in a sitting position. In this embodiment, the handler is to the rear and slightly offset from the animal while reaching over the animal and being able to physically restrain the animal with the shaft pressed against the shoulder of the animal, but yet curving over and around the animal to reach the position of the handler's arm in a comfortable and secure manner.

FIG. 11 shows that the handler can reposition the handling apparatus to an opposite hand during walks or similar movement while still engaging the collar at a low or outside position enabling the handler to engage the animal with either hand comfortably. Further, the bends in the shaft can comfortably drape over or rest against the thigh of the handler to enable the handler to have additional leverage against the animal in trying to advance the animal or restrain the animal while still remaining comfortable and secure to the handler and positioning the animal with an appropriate spacing relative to the handler.

The dog handling apparatus is designed for casual use as well as for training use. The dog handling apparatus provides the handler with a secure and comfortable way to safely walk and manage a dog. Walking the dog is a key component for his/her mental stability. Dogs are wired for walking. Walking your dog successfully requires complete communication between the handler and the dog. The dog handling apparatus functions as an extension of the arm of the handler and the communication between the handler and the dog is immediate.

What is often seen as bad behavior in the dog is actually the handler's failure to communicate with the dog. The dog handling apparatus lets the dog understand what the handler is asking the dog to do, eliminating confusion, making a happier dog and a happier handler. The dog handling apparatus can be used with any level or type of collar and any level of the dog's behavior. The dog handling apparatus is designed for use with a collar that is suitable and comfortable for the dog.

In use, the dog handler can call the dog to him and make the dog sit calmly. The dog handling apparatus can then be attached to the collar while the dog is sitting. The handler can hold the grip of the dog handling apparatus in the right hand with the palm down and thumb forward (like a hand shake). Depending on the size of the handler, strength and level of obedience of the dog, the handler can also place the left hand at the midway bend in the dog handling apparatus for added leverage and stability. The handler can keep the dog on the left side. As the dog progresses, the handler can hold the dog handling apparatus in the left hand only, as the handler will no longer need the right hand.

The handler can begin walking the dog by stepping first with the left leg, as it is the nearest leg to dog. The dog will see it and move with the handler. The dog handling apparatus is designed to walk the dog either beside or behind the handler, rather than in front of the handler such that the dog takes queues from the actions and movement of the handler instead of the opposite. The handler can anticipate the dog pulling and be ready to correct the dog simply by holding the handle firm. This level of control is enabled by the close proximity and quick communication enabled by the dog handling apparatus. The dog will also have an immediate response, with no harsh yanking or jerking. When the handler stops or turns, the handler can continue to hold the handle firm and the dog will stop or turn with the handler.

Alternate embodiments can include variations in size and shape to fit the needs of larger or smaller handlers as well as larger or smaller dogs. The materials of the components such as the bite guard, shaft, grip and lanyard can be coated or infused with reflective or fluorescent materials to increase the visibility of the dog handling apparatus and thereby the safety of using the dog handling apparatus in low light or low visibility scenarios. The dog handling apparatus can also be adapted for use with multiple dogs. In this embodiment, the clasp is sized to receive multiple rings or similar connectors for short straps or leashes for connection with the dog collars or harnesses.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An article for animal training, the article comprising:
a curved cylindrical shaft having a first end and second end;
a grip coupled to the first end of the shaft;
a spring mechanism coupled to the second end of the shaft; and
a clasp coupled to the spring, the clasp to engage an animal collar or harness.

2. The article of claim 1, further comprising:
a sheath coupled to the second end of the shaft, the sheath to cover the spring mechanism.

3. The article of claim 1, wherein the curved cylindrical shaft defines a first bend having approximately a 40 degree angle along a central axis of the shaft from the first end of the shaft.

4. The article of claim 1, wherein the curved cylindrical shaft defines a second bend having approximately a 60 degree angle along a central axis of the shaft.

5. The article of claim 1, wherein the curved cylindrical shaft is a hollow aluminum tube.

6. The article of claim 1, wherein the spring mechanism is a wire coil spring.

7. The article of claim 6, wherein a wire in the wire coil spring has a 0.1 inch diameter.

8. The article of claim 6, wherein the wire coil spring has a first section with a diameter of 0.56 inch.

9. The article of claim 6, wherein the wire coil has a second section with a diameter of 0.74 inch.

10. The article of claim 6, wherein the wire coil has a third section with a diameter of 0.64 inch.

11. The article of claim 1, wherein the grip has an ergonomic shape and is formed from a thermoplastic elastomer.

12. The article of claim 1, further comprising:
a lanyard coupled to the first end of the curved cylinder shaft.

13. The article of claim 12, wherein the grip defines an attachment point for the lanyard.

14. The article of claim 1, wherein the clasp has a releasable attachment mechanism for releasable attachment to the animal collar or harness.

15. The article of claim 2, wherein the sheath is formed of a thermoplastic elastomer.

16. The article of claim 2, wherein the sheath, shaft or grip have fluorescent or reflective surfaces.

17. The article of claim 2, wherein the article has a length of approximately twenty inches.
